(19) United States
(12) Patent Application Publication
(10) Pub. No.: US 2004/0243815 A1
(43) Pub. Date: Dec. 2, 2004

(54) System and method of distributing and controlling rights of digital content

(76) Inventor: Yoshihiro Tsukamura, Riverside, CA (US)

Correspondence Address: Valley Oak Law, 5655 Silver Creek Valley Road, #106, San Jose, CA, 95138, US

(21) Appl. No.: 10/447,404

(22) Filed: May 28, 2003

(51) Int. Cl. H04L 9/32

(52) U.S. Cl. 713/193; 713/202; 713/156

(57) ABSTRACT

A system and method for distributing and controlling digital content are described. The invention allows the authentication of the identity of the user, purchase of licenses for digital content, and playback of digital content by the user on selected player devices. In one embodiment, the system includes distribution center server configured for storing a key for encrypted content; a licensee device configured for communicating with the distribution center server and for storing the key for the encrypted content and a digital certificate of the licensee device; and a gatekeeper device configured for communicating with the licensee device and for receiving the key for the encrypted content and the digital certificated of the licensee device, wherein the gatekeeper device is configured to decrypt the encrypted content, wherein the key for the encrypted content is capable of communicating with multiple gatekeeper devices.

### BACKGROUND OF THE INVENTION

Digital content includes any work that has been produced to a digital format. Specific examples of digital content include software, audio, video, gaming, text, and multimedia content. With the increasing popularity of computers and electronic devices, digital content is utilized by many for both recreational uses and business applications.

By the nature of digital technology, digital content may be perfectly replicated without loss of fidelity in each successive generation of copies. The copied item may be identical to the original copy. For example, copying a software program from one media to another media can be performed without corrupting or modifying the copied version of the software program. The copied version of the software program may be indistinguishable in form and function from the original copy.

Due to the ease in which copies of digital content may be made and the usefulness of these copies, there has been a proliferation illegal copying and distribution of digital content. Illegal copying and distribution of digital content unfairly deprives artists and content owners from revenue and royalties.

### SUMMARY OF THE INVENTION

A system and method for distributing and controlling digital content are described. The invention allows the authentication of the identity of the user, purchase of licenses for digital content, and playback of digital content by the user on selected player devices. In one embodiment, the system includes a distribution center server configured for storing a key for encrypted content; a licensee device configured for communicating with the distribution center server and for storing the key for the encrypted content and a digital certificate of the licensee device; and a gatekeeper device configured for communicating with the licensee device and for receiving the key for the encrypted content and the digital certificated of the licensee device, wherein the gatekeeper device is configured to decrypt the encrypted content, wherein the key for the encrypted content is capable of communicating with multiple gatekeeper devices.

### BRIEF DESCRIPTION OF THE DRAWINGS

The present invention is illustrated by way of example and not limitation in the figures of the accompanying drawings, in which like references indicate similar elements and in which:

FIG. 1 is a simplified block diagram of one embodiment of a distribution and control system.

FIG. 2 is a flow diagram of one embodiment for performing an initialization transaction.

FIG. 3 is a data flow diagram illustrating an initialization transaction according to one embodiment of the system.

FIG. 4 is a flow diagram of one embodiment for performing a registration transaction.

FIG. 5 is a data flow diagram illustrating a registration transaction according to one embodiment of the system.

FIG. 6 is a flow diagram of one embodiment for purchasing a license for content.

FIG. 7 is a data flow diagram illustrating a license purchase transaction according to one embodiment of the system.

FIG. 8 is a flow diagram of one embodiment for accessing content.

FIG. 9 is a data flow diagram illustrating a content access transaction according to one embodiment of the system.

### DETAILED DESCRIPTION

In the following descriptions for the purposes of explanation, numerous details are set forth in order to provide a thorough understanding of the present invention. However, it will be apparent to one skilled in the art that these specific details are not required in order to practice the present invention. In other instances, well-known electrical structures or circuits are shown in block diagram form in order not to obscure the present invention unnecessarily.

A system and method provides the authentication of the identity of the user, purchase of licenses for digital content, and playback of digital content by the user on selected player devices. In one embodiment, once the identity of the user is authenticated, [is it the device or the user using the device being authenticated? Both?] the licensee device which is operated by the user may purchase licenses for digital content. The licensee device may also be configured to interface with player device for rendering the digital content. By interfacing with other devices, the licensee device may authenticate the validity of the license or licenses corresponding to the digital content. The licensee device may also be configured to allow the digital content to be rendered on selected player devices. An individual may be given access to the protected data. In one embodiment, the confidential authenticating data may be stored within the licensee device. In an alternate embodiment, the confidential authenticating data may be store externally to the license device.

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

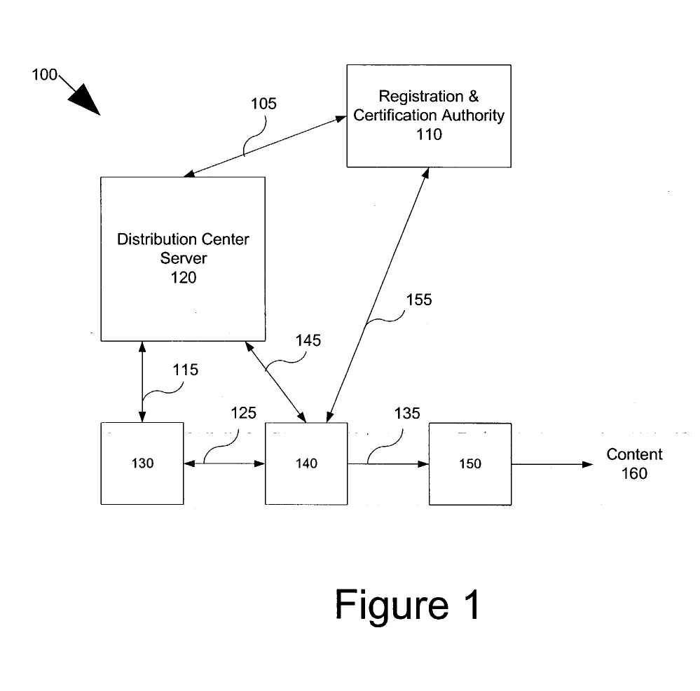

FIG. 1 is a block diagram of one embodiment for a data protection system 100. The data protection system 100 includes a registration and certification authority 110, a distribution center server 120, a licensee device 130, a gatekeeper device 140, a player device 150, and digital content 160.

Transmission between components 110-150 may be via wireless communication such as, for example, mobile telecommunications link, a radio communications link, a satellite link, Bluetooth, infrared, wireless LAN, or the like. Components 110-150 may be connected via a hardwired communication link such as, for example, a virtual private network (VPN), telephone connection, wide are network (WAN), or the like.

Registration and certificate authority 110 may provide both registration and certification of a licensee device 130. In one embodiment, the registration portion verifies user requests for a digital certificate to render digital content. In one embodiment, the registration portion of registration and certification authority may be part of a public key infrastructure that enables companies and users to exchange information and money safely and securely. A digital certificate 110 may contain a public key that is used to encrypt and decrypt messages and digital signatures. The registration portion of registration and certification authority 110 communicates with the certification portion to issue the digital certificate once the identity of the user is authenticated.

In one embodiment, the certification portion of registration and certification authority 110 issues and manages security credentials and public keys for message encryption. As part of a public key infrastructure (PKI), a certification authority checks with a registration authority to verify information provided by the requestor of a digital certificate. In one embodiment, if registration and certification authority 110 verifies the requestor's information, the certification authority may issue a certificate for rendering the digital content.

A digital certificate is analogous to an electronic “credit card” that establishes a user's credentials when doing business or other transactions on the Internet. In one embodiment, registration and certification authority 110 issues the digital certificate.

The digital certificate may include a name, a serial number, expiration dates, a copy of the certificate holder's public key, and the digital signature of the certificate-issuing authority so that a recipient can verify that the certificate is authentic. In one embodiment, the digital certificate may conform to a standard such as the X.509 standard. In one embodiment, the certificate holder's public key is utilized for encrypting messages and digital signatures.

The use of combined public and private keys is known as asymmetric cryptography. A system for using public keys is called a public key infrastructure.

Distribution center server 120 is coupled via communications link 105 to registration and certification authority 110. In one embodiment, distribution center server 120 transmits a public key for distribution center server 120 via communications link 105 to registration and certification authority 110. Registration and certification authority 110 authenticates the digital certificate. Registration and certification authority 110 transmits the authenticated digital certificate via communications link 105 to distribution center server 120.

Licensee device 130 is coupled via communication link 105 to distribution center server 120. In one embodiment, licensee device 130 transmits a payment via communication link 105 to distribution center server 120 and receives encrypted digital content from a digital content source. The encrypted digital content may be transmitted via a network such as the Internet, local network, cellular network, or the like. In one embodiment, licensee device 130 may include a repository to hold licenses and the encrypted digital content. The repository for encrypted content may be within licensee device 130 itself or may be within an external storage device such as a CD-ROM, memory stick, or the like.

In one embodiment, licensee device 130 verifies the identity of the user through a biometric device, a PIN, or a password (or any combination of the three) prior to allowing access to licensee device 130. In one embodiment, licensee device 130 conforms to the standards of a public key infrastructure device. The biometric device includes, for example, a fingerprint or thumbprint scanner, a retinal scanner, a voice recognition unit, a palm reader, or the like. A suitable biometric control device that may be used is described in U.S. Pat. No. 6,453,301 entitled “Method of Using Personal Device With Internal Biometric In Conducting Transactions Over A Network”, which is herein incorporated by reference.

In one embodiment, a user accesses licensee device 130 using a finger or thumbprint input. Alternatively, any means of biometric access may be used. Licensee device 130 uses the biometric input to verify the user of the device. Only a registered user may access licensee device 130 via a biometric device, PIN, and/or password.

Gatekeeper device 140 is coupled via communications link 125 to licensee device 130. In one embodiment, gatekeeper device 140 has cryptographic capabilities and may come preloaded with an asymmetric key pair including a private key and a public key, a digital certificate signed by certification and certificate authority 110. Digital certificates are capable of establishing the authenticity of public keys and ensures that a given public key belongs to the particular device/unit or person as registration and certification authority 110 validates and signs the public key with its own private key. In one embodiment, the proposed standard form for these digital certificates is the X.509 standard.

Player device 150 is coupled via communications link 135 to gatekeeper device 140. In one embodiment, player device 150 may be a software player similar to a media player on a computer system which can play digital content. In another embodiment, the player device 150 may also be a personal digital audio/video system such as a DVD player, a CD player, a television, or the like. In another embodiment, player device 150 may be a reader/viewer configured to read electronic text.

In one embodiment, player device 150 receives the compressed digital content via communications link 135 from gatekeeper device 140.

In an alternate embodiment, gatekeeper device 140 and player device 150 may be combined into one unit. In this alternate embodiment, player device 150 may be selectively coupled with licensee device 130.

In one embodiment, player device 150 decompresses the digital content and renders the digital content into an analog form for presentation to the user.

Components 110-150 are illustrated in FIG. 1 as one embodiment of system 100. Although components 110-150 are illustrated in FIG. 1 as separate components of system 100, two or more of these components may be integrated, thus decreasing the number of components in system 100. Similarly, any one of components 110-150 may also be separated, thus increasing the number of components within system 100. Further, components 110-150 may be implemented in any combination of hardware, firmware, and software.

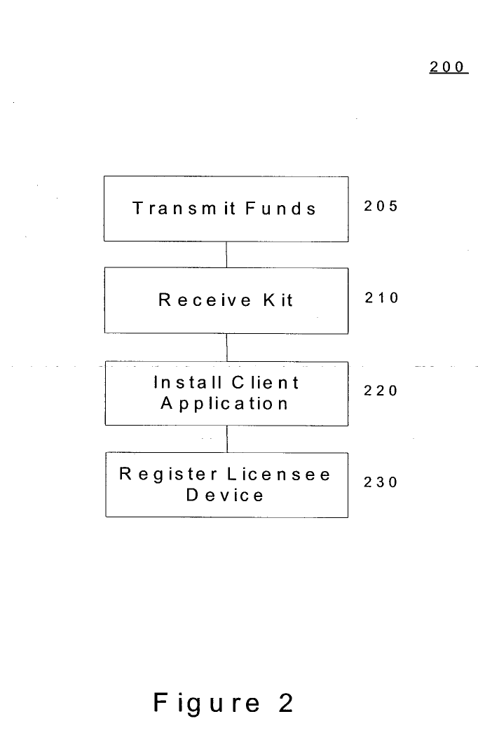

Exemplary operations of system 100 of FIG. 1 are described with references to the flow diagrams shown in FIGS. 2, 4, 6, and 8.

The flow diagrams as depicted in FIGS. 2, 4, 6, and 8 illustrate one embodiment of the invention. The blocks may be performed in a different sequence than shown without departing from the spirit of the invention. Further, blocks may be deleted, added or combined without departing from the spirit of the invention.

FIG. 2 is a flow diagram 200 of one embodiment for performing initialization and registration of licensee device 130. At Block 205, a user transmits a request to purchase licenses to digital content. In one embodiment, the user may transmit the request from gatekeeper device 140 via communications link 145 to distribution center server 120. In this embodiment, distribution center server 120 forwards the request via communication link 105 to registration and certification authority 110. Alternatively, gatekeeper device 140 may transmit the request directly to registration and certification authority 110. In one embodiment, the user may transmit payment authorization to registration and certification authority 110 for the purchase of the license. The payment authorization may be in the form of a direct payment of funds, transfer of funds from a third party, or any suitable form of payment authorization. In one embodiment, registration and certification authority 110 is a trusted third party and includes the necessary hardware and software environment to enable the licensee device 130 to render the digital content.

At Block 210, a welcome kit is received. In one embodiment, the welcome kit is received by gatekeeper device 140 via communications link 155 from registration and certification authority 110. Alternatively, the welcome kit may be received by gatekeeper device 140 via communications link 115 from distribution center server 120. In this alternate embodiment, distribution center server 120 receives the welcome kit via communications link 105 from registration and certification authority 110. The welcome kit is transmitted to gatekeeper device 140 after registration and certification authority 110 approves the request. The welcome kit may include a client application, licensee device identification, a website address, setup identification, and a password.

At Block 220, the client software is installed and initialized. In one embodiment, the client software is installed and initialized within gatekeeper device 140. In an alternate embodiment, the client software is installed and initialized within licensee device 130.

At Block 230, licensee device 130 is registered. In one embodiment, licensee device 130 is registered with registration and certification authority 110.

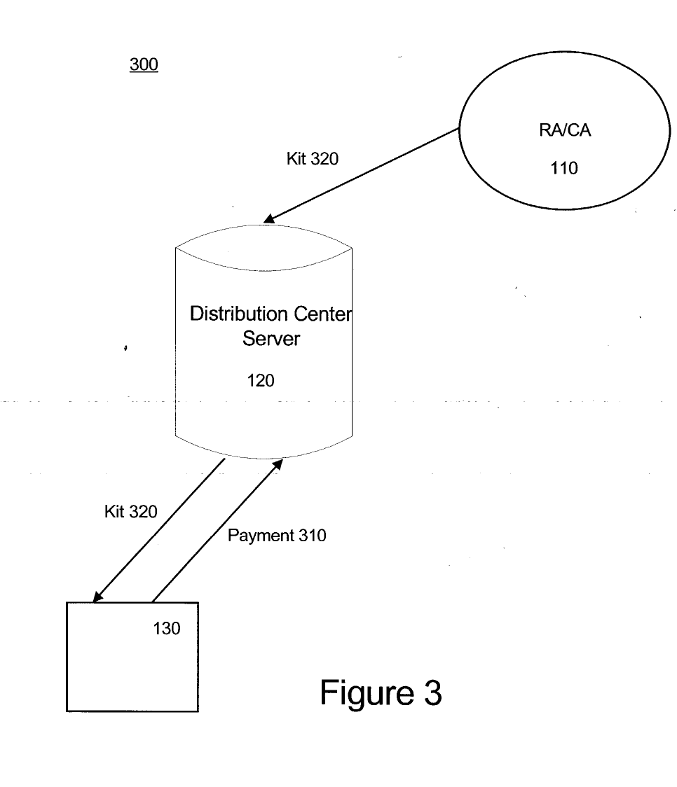

FIG. 3 is a simplified data flow diagram 300 that provides an exemplary data flow corresponding to the flow diagram 200 in FIG. 2. Common references numerals are utilized in FIGS. 1 and 3 for the sake or clarity. A payment 310 is shown from licensee device 130 to distribution center server 120, which corresponds to Block 205. A kit transfer 320 is shown from registration and certification authority 110 to licensee device 130, which corresponds to Block 210.

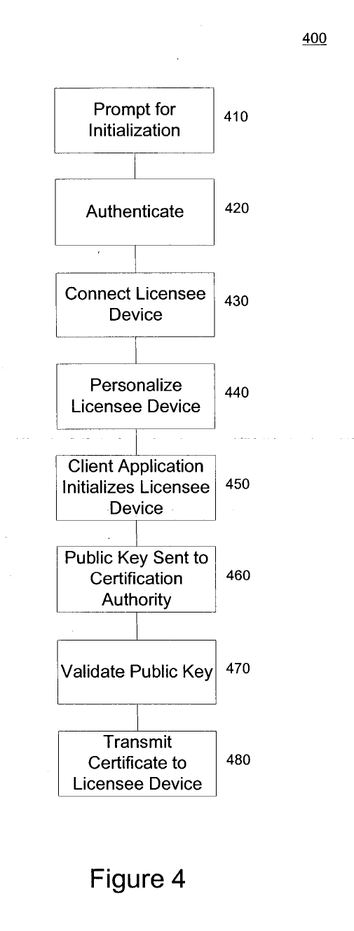

FIG. 4 is a flow diagram 400 of one embodiment for registering licensee device 130. At Block 410, an initialization is prompted. In one embodiment, a setup identification and/or a password are transmitted from licensee device 130 via communications link 115 and 105 to registration and certification authority 110. Alternatively, the setup identification and password may be transmitted directly to licensee device 130 via communications link 155. In yet another alternate embodiment, the setup identification and password may be transmitted through gatekeeper device 140.

At Block 420, the user is authenticated. In one embodiment, registration and certification authority 110 authenticates the validity of the user based on the setup identification and password.

At Block 430, licensee device 130 is connected with the gatekeeper device 140. In an alternate embodiment, gatekeeper device 140 may be incorporated within a personal computer. In this alternate embodiment, licensee device 130 may be connected to the personal computer through a USB port or similar connection.

At Block 440, licensee device 130 may be personalized by the user. In one embodiment, the user initializes licensee device 130 with a PIN. In an alternate embodiment, the user initializes licensee device 130 with a biometric scanning device such as a fingerprint or thumbnail scanner. In this alternate embodiment, the biometric scanning device transmits a biometric parameter to licensee device 130 for user identification. The biometric parameter is stored within a protected area of licensee device 130. The personalization process allows licensee device 130 to recognize and authenticate the identity of the user.

At Block 450, the licensee device 130 is initialized. In one embodiment, the client application initialized the licensee device 130. In one embodiment, licensee device 130 receives an embedded command such that a key pair is generated within licensee device 130. In one embodiment, the key pair includes both a private key and a public key.

At Block 460, the public key of licensee device 130 is sent to registration and certification authority 110.

At Block 470, the public key of licensee device 130 is validated. In one embodiment, registration and certification authority 110 validates the public key of licensee device 130. In one embodiment, the validation of the public key occurs by signing the public key of licensee device 130 with a private key of registration and certification authority 110.

At Block 480, a digital certificate is created and transmitted to licensee device 130. In one embodiment, registration and certification authority 110 creates a digital certificate and transmits the digital certificate to licensee device 130. In one embodiment, the digital certificate is signed with the private key of registration and certification authority 110. In one embodiment, the digital certificate may conform to the X.509 protocol format. The public key of registration and certification authority 110 is also sent to licensee device 130. In one embodiment, the digital certificate and public key of registration and certification authority 110 is stored within licensee device 130.

The flow diagrams within FIGS. 2 and 4 illustrate one embodiment in which a user is equipped with necessary hardware and software systems to procure symmetrically encrypted digital content files and to purchase licenses to play the contents in a secure environment.

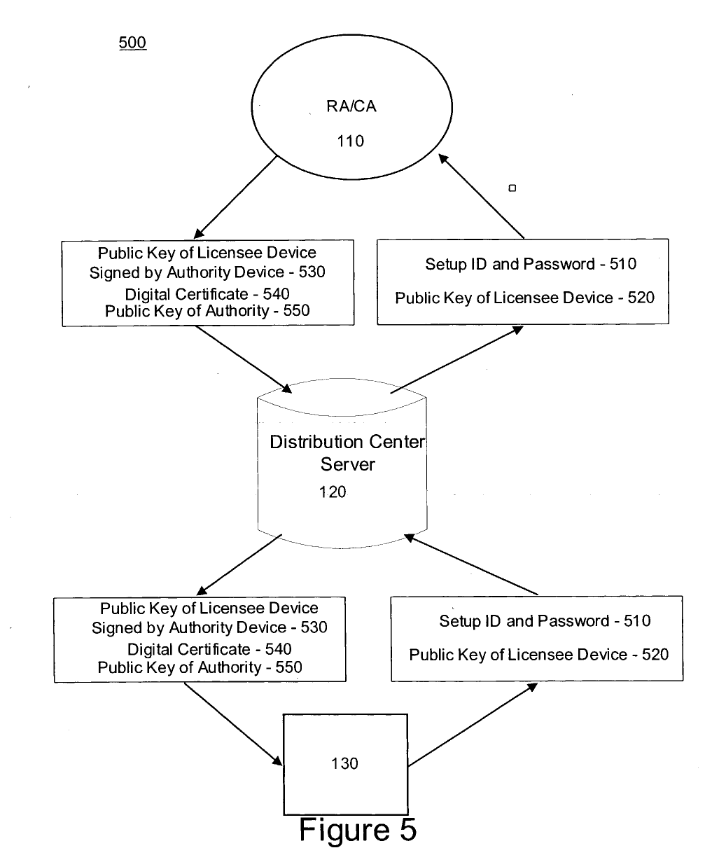

FIG. 5 is a simplified data flow diagram 500 that provides an exemplary data flow corresponding to the flow diagram 400 in FIG. 4. Common references numerals are utilized in FIGS. 1 and 5 for the sake or clarity. A setup ID and password transfer 510 is shown from licensee device 130 to registration and certification authority 110, which corresponds to Block 410. A public key of the licensee device transfer 520 is shown from licensee device 130 to registration and certification authority 110, which corresponds to Block 460.

A public key of licensee device 130 signed by registration and certification authority device transfer 530 is shown from registration and certification authority 110 to licensee device 130, which corresponds to Block 480. A digital certificate by the registration and certification authority module transfer 530 is shown from registration and certification authority 110 to licensee device 130, which corresponds to Block 480.

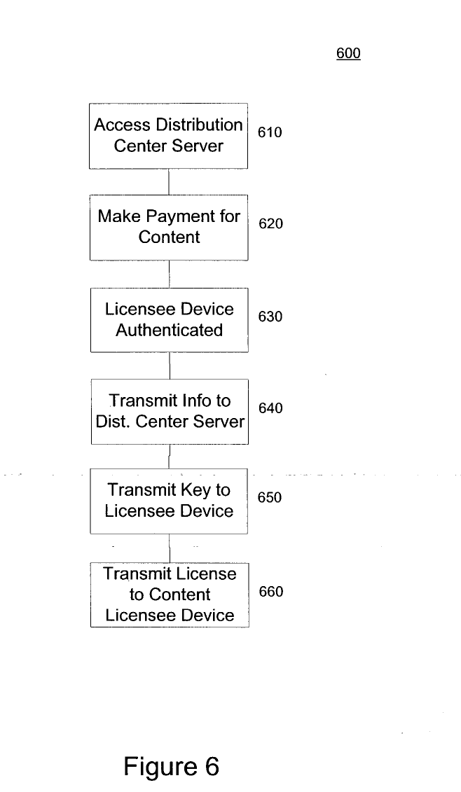

FIG. 6 is a flow diagram 600 of one embodiment for purchasing a license to utilize digital content. A user can procure symmetrically encrypted digital content files through downloads or on storage media, such as CD-ROM, through the mail or from Internet sites or other broadcast centers.

At Block 610, the user accesses distribution center server 120. At Block 620, the user may make a payment for a license to digital content. In one embodiment, the user may make a payment to distribution center server 120 for a license to digital content. At Block 630, licensee device 130 is authenticated by distribution center server 120.

At Block 640, information related to the license for the digital content is transmitted to distribution center server 120 from licensee device 130. This information may include identification of the digital content for which a license is sought, identification of licensee device 130, identification of gatekeeper devices 140 that are associated with player devices 150 to render the digital content, and the time period for the license to the digital content.

At Block 650, a symmetric key for the encrypted digital content is transmitted to licensee device 130 from distribution center server 120. The key is a specific symmetric key for the encrypted digital content file wrapped in the public key of gatekeeper device 140. If the user is interested in playing the digital content on more than one player device 150, distribution center server 120 may send a separate public key for each gatekeeper device 140 with the symmetric key wrapped therein.

At Block 660, a license corresponding to the encrypted digital content is transmitted to licensee device 130 from distribution center server 120. In one embodiment, the license is signed by the private key of distribution center server 120. Additionally, the public key of distribution center server 120 is transmitted to licensee device 130. In one embodiment, the symmetric key, public key of distribution center server 120, and the license are stored in licensee device 130.

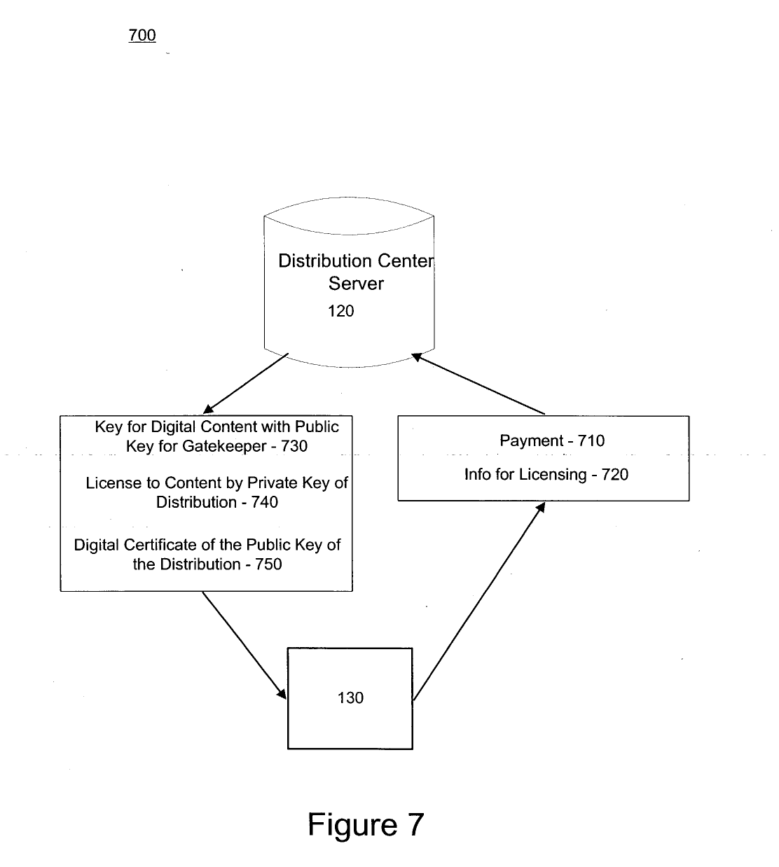

FIG. 7 is a simplified data flow diagram 700 that provides an exemplary data flow corresponding to the flow diagram 600 in FIG. 6. Common references numerals are utilized in FIGS. 1 and 7 for the sake or clarity. A payment 710 is transferred from licensee device 130 to distribution center server 120, which corresponds to Block 620. An information for licensing 720 is transferred from licensee device 130 to distribution center server 120, which corresponds to Block 640. A key 730 is transferred from distribution center server 120 to licensee device 130, which corresponds to Block 650.

A license 740 is transferred from distribution center server 120 to licensee device 130, which corresponds to Block 660. A digital certificate 750 is transferred from distribution center server 120 to licensee device 130, which corresponds to Block 660.

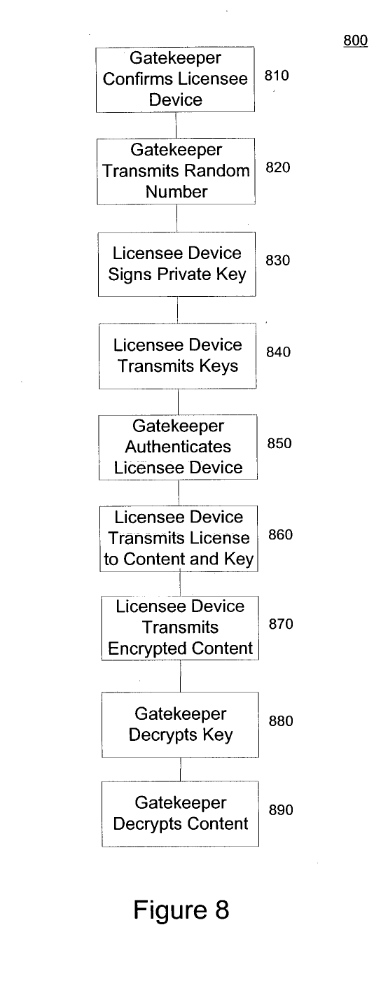

FIG. 8 is a flow diagram 800 of one embodiment for rendering digital content with a license. A user can render the digital content on any rendering system that has a valid gatekeeper device 140.

At Block 810, gatekeeper device 140 confirms the presence of licensee device 130. At Block 820, gatekeeper device 140 generates a unique random number and transmits the random number to licensee device 130. At Block 830, licensee device 130 digitally signs the random number with its private key. At Block 840, licensee device 130 transmits the random number signed by its private key and the public key of the digital certificate belonging to licensee device 130 back to gatekeeper device 140.

At Block 850, gatekeeper device 140 authenticates the identity of licensee device 130 by decrypting the random number with the public key of licensee device 130. Gatekeeper device 140 also validates the digital certificate received from licensee device 130 by authenticating it with the public key of registration and certification authority 110.

At Block 860, licensee device 130 transmits the license to the digital content and the symmetric key corresponding to the particular digital content to gatekeeper device 140.

At Block 870, gatekeeper device 140 decrypts the license and checks the validity of license with the system clock.

At Block 880, gatekeeper device 140 decrypts the symmetric key with the private key from gatekeeper device 140, which is wrapped in the public key of gatekeeper device 140.

At Block 890, gatekeeper device 140 decrypts the digital content with the symmetric key and loads the decrypted digital content onto player device 150 for rendering an analog representation of the digital content.

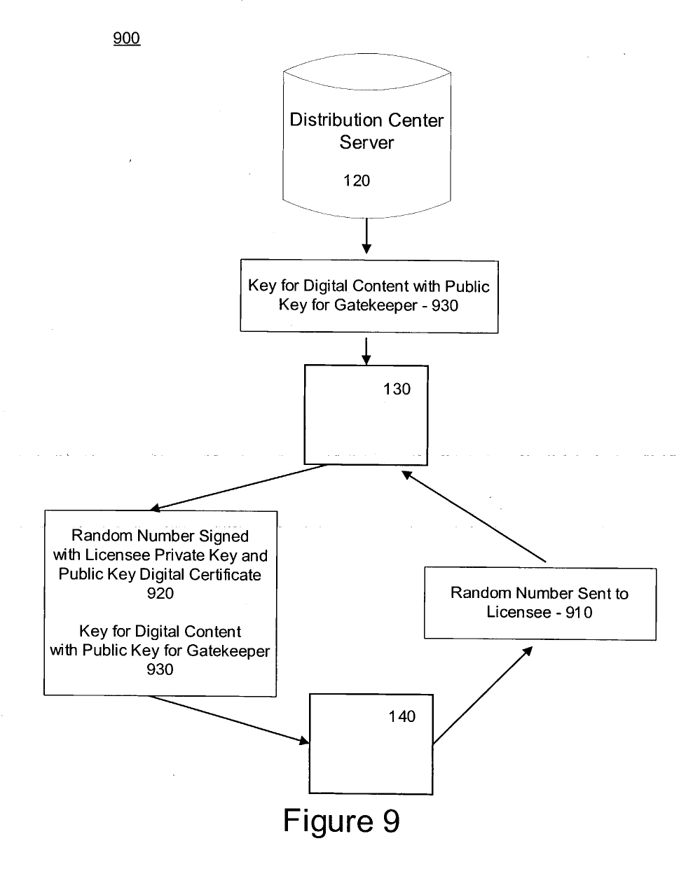

FIG. 9 is a simplified data flow diagram 900 that provides an exemplary data flow corresponding to the flow diagram 800 in FIG. 8. Common references numerals are utilized in FIGS. 1 and 9 for the sake or clarity. A random number 910 is transferred from gatekeeper device 140 to licensee device 130, which corresponds to Block 820. A random number signed by the licensee device's private key 920 is transferred from licensee device 130 to gatekeeper device 140, which corresponds to Block 840. A key for the digital content 930 is transferred from distribution center server 120 to gatekeeper device 140, which corresponds to Block 860.

The foregoing descriptions of specific embodiments of the invention have been presented for purposes of illustration and description.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A system comprising:
distribution center server configured for storing a key for encrypted digital content;
a licensee device configured to communicate with the distribution center server and to store the key for the encrypted digital content and a digital certificate of the licensee device; and
at least one gatekeeper device configured to communicate with the licensee device, to receive the key for the encrypted content and the digital certificate of the licensee device, and to decrypt the encrypted digital content.

2. The system according to claim 1 wherein the licensee device further comprises an identity authentication module configured to authenticate a user.

3. The system according to claim 2 wherein the identity authentication module is configured to receive a personal identification number.

4. The system according to claim 2 wherein the identity authentication module is configured to receive a biometric parameter from a biometric device.

5. The system according to claim 4 wherein the biometric device is selected from the group consisting of a fingerprint scanner, a retinal scanner, a voice recognition device, and a palm scanner.

6. The system according to claim 4 wherein the authentication module is configured to receive a password.

7. The system according to claim 1 further comprising a player device configured to communicate with the at least one gatekeeper device and to render decrypted content.

8. The system according to claim 1 further comprising a registration and certification authority configured to communicate with the distribution center server and to authenticate the licensee device.

9. A method comprising:
receiving a welcome kit wherein the welcome kit includes a client application;
installing the client application; and
registering a licensee device with a registration and certification authority wherein the licensee device is configured to authenticate content with at least one gatekeeper device.

10. The method according to claim 9 further transmitting a payment to a distribution center server.

11. The method according to claim 9 further authenticating an identity of a user.

12. The method according to claim 9 further programming the licensee device with a user identification.

13. The method according to claim 12 wherein the user identification is a biometric parameter.

14. The method according to claim 12 wherein the user identification is a personal identification number.

15. The method according to claim 9 further generating a public key and a private key within the licensee device.

16. The method according to claim 15 further transmitting the public key to the registration authority and certification authority module.

17. The method according to claim 15 further validating the public key at the registration authority and certification authority module.

18. The method according to claim 15 further transmitting a digital certificate in response to the public key received by the registration authority and certification authority module.

19. A method comprising:
means for receiving a welcome kit wherein the welcome kit includes a client application;
means for installing the client application; and
means for registering a licensee device with a registration authority and certification authority module wherein the licensee device is configured to authenticate content among multiple gatekeeper modules.

20. A method comprising:
transmitting a payment to a distribution center server for content;
transmitting information to the distribution center server wherein the information corresponds to a license for the content;
transmitting a key for the content to a licensee device in response to the information; and
transmitting a license to the licensee device, wherein the license authorizes the content to be rendered.

21. The method according to claim 20 wherein the license specifies a time period that the license is effective.

22. The method according to claim 20 wherein the license specifies a number of player devices that the license is effective with.

23. The method according to claim 20 wherein the license specifies the licensee device that the license is effective with.

24. The method according to claim 20 wherein the key is a symmetric key.

25. The method according to claim 20 further comprising storing the key and the license within the licensee device.

26. A method comprising:
means for transmitting a payment to a distribution center server for content;
means for transmitting information to the distribution center server wherein the information corresponds to a license for the content;
means for transmitting a key for the content to a licensee device in response to the information; and
means for transmitting a license to the licensee device, wherein the license authorizes the content to be rendered.

27. A method comprising:
authenticating an identity of a licensee device with a gatekeeper device;
transmitting a key for content from the licensee device to the gatekeeper device;
transmitting a license from the licensee device to the gatekeeper device; and
decrypting the content in response to the license.

28. The method according to claim 27 wherein authenticating further comprising generating a random number within the gatekeeper module and transmitting the random number to the licensee device.

29. The method according to claim 28 wherein authenticating further comprising generating signing the random number with a private key of the licensee device and transmitting the random number signed by the private key and a public key certificate of the licensee device to the gatekeeper device.

30. The method according to claim 29 wherein authenticating further comprising decrypting the random number with a public key of the licensee device and verifying validity of the public key certificate of the licensee device with a registration authority and certification authority module.

31. The method according to claim 27 further comprising loading the decrypted content to a player device wherein the player device is configured to render the decrypted content in an analog form.

32. A method comprising:
means for authenticating an identity of a licensee device with a gatekeeper device;
means for transmitting a key for content from the licensee device to the gatekeeper device;
means for transmitting a license from the licensee device to the gatekeeper device; and
means for decrypting the content in response to the license.
